(19) United States
(12) Patent Application Publication
(10) Pub. No.: US 2002/0014404 A1
(43) Pub. Date: Feb. 7, 2002

(54) Anode, a process for the manufacture thereof and a process for the production of aluminum

(76) Inventors: Jose Ricardo Duarte de Carvalho, Belem, PA (US); Eduardo Baprista Sarcinelli, Barcarena, PA (US); Deusa Maria Braga Dognini, Barcarena, PA (US)

Correspondence Address: Helfgott & Karas, P.C., 60th Floor, Empire State Building, New York, NY, 10118, US

(21) Appl. No.: 09/832,749

(22) Filed: Apr. 11, 2001

Related U.S. Application Data
(63) Continuation-in-part of application No. 09/123,610, filed on Jul. 28, 1998, now Pat. No. 6,235,184.

(30) Foreign Application Priority Data
Nov. 20, 1998 (BR) CI 9800469-7

(51) Int. Cl. C25C 7/02; C25C 3/06; C09C 1/44

(52) U.S. Cl. 204/294; 23/314; 264/105; 313/327; 205/372

(57) ABSTRACT

The present invention refers to an anode composition comprising as binding agent the sugar cane molasses, mascavo sugar, brown sugar or demerara, VHP, crystal, refined or hard sugar, instead of the conventional electrolytic pitch. The composition may optionally include additives based on lithium, fluorine, aluminum, boron and sulfur, and is used in a process for the manufacture of anodes for the primary aluminum industry. The invention also refers to a process for the manufacture of said anode and the application thereof to the primary aluminum industry.

### CROSS-REFERENCE TO RELATED APPLICATION

This application is a continuation-in-part of application Ser. No. 09/123,610, filed on Jul. 28, 1998.

### FIELD OF THE INVENTION

The present invention refers to a new material for the manufacture of anodes used in the processes for the electrolytic production of primary aluminum.

More specifically, the present invention refers to a new type of anode which composition comprises sugar cane molasses, mascavo sugar, crystal sugar, brown sugar, VHP sugar, refined sugar, or hardened sugar or molasses as binding agent.

Therefore, the present invention refers to the replacement of electrolytic pitch usually employed in conventional anode manufacturing processes for the primary aluminum industry. The electrolytic pitch is replaced by sugar cane molasses, primary sugar honey, mascavo sugar, crystal sugar, brown sugar, VHP sugar, refined sugar, or hardened sugar or molasses, either pure or provided with additives.

### BACKGROUND OF THE INVENTION

The aluminum industry techniques have been known for more than a century in all the aluminum plants all over the world such as, for example, the Hall-Heroult process. Such premises usually incorporate attached thereto what we know as anode plants which are essential elements in this kind of industry.

The process for manufacturing anodes presently in use comprises the production of a mixture of petroleum coke with residual reduction anodes known as butts, and electrolytic pitch which is obtained from the tar. The first two ingredients, that is, petroleum coke and residual reduction anodes are submitted to crushing, sieving and classifying operations in specific granulometric fractions in such a way that after they are mixed, they may produce the highest “packing” degree that can be attained for the purpose of using as little binding agent and obtaining the best mechanical properties for the anode.

All the above mentioned fractions are heated and subsequently mixed to the electrolytic pitch. This operation is carried out in continuous or batch mixers by using temperature range from 80° C. to 350° C. depending on the process used.

The result of the mixing step described above is a slurry which may be directly used in the electrolytic reduction vats when the aluminum is produced through Söderberg process, for producing the required anode for the reduction process. Said anode is produced by baking said slurry in the heat of the reduction vats which operate at temperature from 900° C. to 1,000° C.

Alternatively, said slurry may also be pressed or compacted or vibrocompacted in suitable presses or compactors, with or without vacuum, in order to produce green anodes which are usually designed to be used in the process known as pre-baked process.

However, before being used in the pre-baked reduction process, said green anodes should be submitted to baking in special furnaces which may be open or closed. In such furnaces, the green anodes are baked within a temperature range from 900° C. to 1,200° C. in order to attain the required physical and chemical properties to be used in furnaces for reducing alumina to primary aluminum.

It is also known by those skilled in the art that during the process for the preparation of the above-mentioned anodic slurry for the Söderberg process, as well as during the process for baking the green anodes for the pre-baked process, aromatic components are released from the electrolytic pitch and despite the fact that they are below the limits set out by the regulations of a number of countries they are deleterious either by inhalation or contact and the result is a noxious environment.

Another typical inconvenience from the use of electrolytic pitch is that since it is in the solid form dust is generated and often the plant operators get burned by exposing the skin in contact with the dust under the sun. Said burns are deemed as quite severe.

Another inconvenience in the use of solid electrolytic pitch is related to the dirty caused in the plant area and the frequent problems at navigation ports when handling the electrolytic pitch which is usually transported by ships.

Trying to minimize the above-mentioned inconveniences, systems based on the gas treatment in association or not with efficient dust removing systems have been used. Also to minimize said inconveniences it has been tried to replace solid electrolytic pitch by liquid electrolytic pitch. However, such resources are not fully efficient and demand very high investment costs.

### OBJECTS OF THE INVENTION

Therefore, an object of the present invention is to provide a new anode material to be used in processes for the electrolytic production of primary aluminum which material shall not bring about an insalubrious environment during the process for the preparation of the anodic slurry and/or during the baking process.

Another object of the present invention is to provide a new anode material to be used in processes for the electrolytic production of primary aluminum which production process should not produce dirt in the plant area as well as overcome the frequent problems of handling the raw material for manufacturing said anodes found in navigation ports.

Another object of the present invention is to provide a new anode material to be used in processes for the electrolytic production of primary aluminum which material should not cause any damage to the health of operators.

Another object of the present invention is to provide a new anode material to be used in processes for the electrolytic production of primary aluminum which process should not be aggressive to the environment close to the producing process area.

Still another object of the present invention is to provide a process for the electrolytic production of primary aluminum which does not require sophisticated gas treatment systems and/or dust removing systems in the anode plants, so that the accomplishment of the process as a whole may be cost-effective.

### DETAILED DESCRIPTION OF THE INVENTION

These and other objects and advantages of the present invention are accomplished by using sugar cane molasses, primary sugar honey, mascavo sugar, crystal sugar, brown sugar, VHP sugar, refined sugar, or hardened sugar or molasses, either pure or provided with additives, as the binding agent in the manufacture of anodes used in processes for the electrolytic production of primary aluminum.

Said sugar cane molasses, primary sugar honey, mascavo sugar, crystal sugar, brown sugar, VHP sugar, refined sugar, or hardened sugar or molasses, either pure or provided with additives, is used instead of the traditional solid or liquid electrolytic pitch.

Within the scope of the present invention, “sugar cane molasses” should mean the main honey (syrup) for producing molasses or the sugar production waste. Primary sugar honey is a whole syrup before the sugar is removed therefrom. Mascavo sugar is a material with a sucrose content between 88 and 90%, the balance being comprised of impurities. Crystal sugar is a material with a sucrose content between 99.8 and 99.92%, the balance being comprised of impurities. Brown sugar, sometimes called demerara, is a material with a sucrose content between 80 and 85%, the balance being comprised of impurities. VHP (Very High Pol) sugar is a material with a sucrose content between 99 and 99.4%, the balance being comprised of impurities. Refined sugar is a material with a sucrose content between 99.93 and 99.98%, the balance being comprised of impurities. Hardened sugar or molasses is a material with a sucrose content lower than 80%, the balance being comprised of impurities.

As additives in the present invention, mention could be made to substances based on lithium, fluorine, alumina, boron, sulfur and the mixtures thereof, provided that such additives do not have properties and performance similar or close to those shown by anodes produced from electrolytic pitch.

The technique for using sugar cane molasses, primary sugar honey, mascavo sugar, crystal sugar, brown sugar, VHP sugar, refined sugar, or hardened sugar or molasses as binding agent for making the slurry and the green anode according to the present invention is similar to that of traditional processes for producing electrolytic pitch-based anodes which is widely known in the aluminum industry. However, the coke, the butts and the sugar cane molasses, primary sugar honey, mascavo sugar, crystal sugar, brown sugar, VHP sugar, refined sugar, or hardened sugar or molasses content is variable in addition to other conditions of the process such as the mixture temperature, the baking temperature and the time which vary according to the type of coke, binding agent itself, additives and/or the required properties for the anode to be produced.

Thus, the composition of the anode according to a first embodiment of the present invention comprises about 50 to 70% by weight of petroleum coke, from 15 to 30% by weight of butts and 15 to 25% by weight of sugar cane molasses.

Preferably, the percentage of sugar cane molasses used in the anode composition according to the first embodiment of the present invention is about 18% by weight based on the total composition weight.

In addition, according to the present invention the additives, the substances based on lithium, fluorine, aluminum, alumina, boron, sulfur and the mixtures thereof may be included in percentages varying from about 0 to 10% by weight.

According to the first embodiment of the present invention, the process for manufacturing anode comprises the preparation of a mixture containing petroleum coke, residual reduction anodes and sugar cane molasses. The petroleum coke and the residual- anodes are crushed, sieved and classified in specific granulometric fractions. The granulometric fractions thus obtained are heated and mixed with the sugar cane molasses in continuous or batch mixers at temperature ranging from 100° C. to 250° C. Preferably, the temperature is approximately 155° C. The mixing time shall depend on the type and capacity of the mixing equipment used in the process.

The product of this mixing is a slurry which may be either directly used in electrolytic reduction vats or pressed or compacted or vibrocompacted in proper presses or compactors, with or without vacuum, in order to produce green anode.

Said green anodes may then be submitted to baking in special furnaces at temperature ranging from 800° C. to 1,300° C. for a time ranging from 70 to 200 hours. Preferably, the baking temperature is about 1,100° C.

The slurry obtained as above-cited may be directly used in the Soderberg process, while the green anodes may be used in the pre-baked process after have been baked.

According to the first embodiment of the present invention the typical composition of molasses to be used in the composition of anode have preferably the characteristics given on Table I below that may occur individual or simultaneously.

TABLE I

| | RANGE | UNIT |
|---|---|---|
| PARAMETER | | |
| Refractometric | 75-83 | % |
| Brix | | |
| Pol | 37-63 | % |
| Purity | 50-75 | % |
| Reducing sugars | 3-10 | % |
| Conductive ashes | 6-10 | % |
| IMPURITIES: | | |
| Iron | 200 max. | ppm |
| Silicon | 250 max. | ppm |
| Nickel | traces | |
| Vanadium | 150 max. | ppm |
| Calcium | 200 max. | ppm |
| Sodium | 100 max. | ppm |

ppm - parts per million
max. - = maximum
Pol = sucrose content

According to the first embodiment of the present invention, the typical composition of the petroleum coke to be used in the anode composition preferably has the characteristics given on Table II below that may occur individual or simultaneously.

TABLE II

| | RANGE | UNIT |
|---|---|---|
| PARAMETER | | |
| Apparent density | 0.8-0.9 | g/cm³ |
| Real density | 1.9-2.1 | g/cm³ |
| Volatiles | 0.1-0.5 | % |
| Ashes | 0.1-0.6 | % |
| Humidity | 0-0.3 | % |
| IMPURITIES: | | |
| Iron | 400 max. | ppm |
| Silicon | 300 max. | ppm |
| Nickel | 300 max. | |
| Vanadium | 400 max. | ppm |
| Sodium | 200 max. | ppm |
| Calcium | .300 max. | ppm |
| Sulfur | 3.0 max. | % |

ppm = parts per million
max. = maximum

It should be noted that the term conductive ashes in TABLE I refers to the content of ionized soluble salts present in a sugar solution, measured through its electrical conductivity, whereas the term ashes in TABLE II refers to the mineral waste remaining after a sample is fired.

The following example shows the conditions of a preferred first embodiment of the present invention. However, said example should not be deemed as limitation of the scope and conditions herein described above and claimed.

### EXAMPLE

Comparative laboratory tests were performed in order to attain the best parameters possible to be used as reference for the industrial process for producing pre-baked anodes for the primary aluminum industry. The conditions of the anode composition and the process for the manufacture thereof were modified according to the experiments. The experiments were conducted in a bench scale available from R&D Carbon Ltd. (R.D.C.), a Swiss company. Five (5) kg of slurry were produced in each experiment which is equivalent to the manufacture of 14 anodes weighing 340 g each one.

The average composition of the sugar cane molasses used in the anode composition in the experiments is as follows:

Purity: 41.3%

Refractometric Brix: 78.3%

Pol: 32.3%

Reducing sugars: 32.4%

The process features leading to the best results are the following:

Sugar cane molasses concentration: 18%-20%

Mixing temperature: 135° C.-155° C.

Baking temperature: 1,100° C.

The anodes of the present invention were compared to conventional anodes using electrolytic pitch as binding agent The results are given on Table III below.

TABLE III

| | INVENTION | | | CONV. |
|---|---|---|---|---|
| | (molasses) | | | (pitch) |
| | 18% | 18% | 20% | 14,5% |
| PARAMETER | ST = 4 h | ST = 20 h | ST = 20 h | ST = 20 h |
| Apparent density (GA); | 1.583 | 1.607 | 1.610 | 1.577 |
| g/cm³ | | | | |
| Apparent density (BA); | 1.442 | 1.446 | 1.471 | 1.530 |
| g/cm³ | | | | |
| Real density; g/cm³ | 2.093 | 2.089 | 2.090 | 2.125 |
| Mechanical strength; | 318 | 224 | 209 | 263 |
| kgf/cm² | | | | |
| Electrical resistivity; | 8.583 | 8.738 | 7.541 | 7.995 |
| μ.ohm.cm | | | | |
| Air permeability, nPm | 1.563 | 1.582 | 1.401 | 1.982 |
| Thermal conductivity; | 2.12 | 2.16 | 2.10 | 2.1 |
| w/m °k. | | | | |
| Residual air | 55.7 | 69.5 | 68.9 | 71.6 |
| resistivity; % | | | | |
| Residual CO₂ | 58.2 | 57.5 | 65.4 | 81.5 |
| reactivity; % | | | | |

ST = soaking time at the baking temperature; in hours
GA = green anode
BA = baked anode

In alternate embodiments of the invention, the technique of using primary sugar honey, mascavo sugar, brown sugar or demerara, VHP, crystal, refined, or hard sugar as binder in the manufacture of the paste and green anodes, is identical to that of the traditional processes for production of anodes based on electrolytic pitch, which are widely known in the aluminum industry.

Similarly, the primary sugar honey, mascavo sugar, brown sugar or demerara, VHP, crystal, refined or hard sugar contents and also coke and anode butts, as well as the process conditions such as, the temperature of the mixture, the baking temperature and time, represent parameters that can be altered depending on the types of coke, primary sugar honey, mascavo sugar, brown sugar or demerara, VHP, crystal, refined or hard sugar and additives, and/or the properties required for the anode produced.

Therefore, the anode composition according to the present improvement, comprises about 50%-70% of petroleum coke, 15%-30% of anode butts and l0%-25% of primary sugar honey, mascavo sugar, brown sugar or demerara, VHP, crystal, refined or hard sugar, based in the total weight of the composition.

Preferably, the percentage of primary sugar honey, mascavo sugar, brown sugar or demerara, VHP, crystal, refined or hard sugar used in the anode composition according to the alternate embodiments is about 16% by weight.

The additives, lithium, fluorine, aluminum, alumina, boron and sulfur based substances and the mixtures, thereof, according to the present improvement, may also be included in percentages varying from 0 to about 10% by weight.

The process for the manufacture of anodes according to the alternate embodiments comprises, the preparation of a mixture containing petroleum coke, anode butts, primary sugar honey, mascavo sugar, brown sugar or demerara, VHP, crystal refined or hard sugar. The petroleum coke and the anode butts are crushed, screened and classified into appropriate sized fractions. Next, such fractions are heated and mixed with primary sugar honey, mascavo sugar, brown sugar or demerara, VHP, crystal, refined or hard sugar, in continuous or batch mixers, at temperatures ranging from 150° C. to 250° C. Preferably, the suitable temperature is around 190° C., and the mixing time depends on the type and capacity of the mixing equipment used in the process.

The paste resulting from this mixing can be directly used in electrolytic reduction pots or be pressed or compacted or vibro-compacted in suitable presses or compacting machines, with or without vacuum, to form green anodes.

These green anodes can be baked in special furnaces at temperatures ranging from 800° C. to 1300° C. for a time ranging from 70 to 200 hours. Preferably, the baking temperature is about 1100° C.

The above paste can be directly used in the Söderberg process, while the green anodes, after being baked, can be used in the “prebaked” process. Both the Söderberg and Prebaked processes are used for primary aluminum production.

According to the alternate embodiments of the invention, the typical composition of the primary sugar honey, mascavo sugar, brown sugar or demerara, VHP, crystal, refined or hard sugar to be used in the anode composition shows the features given in Table IV, which can occur individually or simultaneously.

TABLE IV

| | RANGE | UNIT |
|---|---|---|
| PARAMETER | | |
| Refractometric Brix | 75-83 | % |
| Pol* | 37-63 | % |
| Purity* | 50-75 | % |
| Reducing sugars* | 3-10 | % |
| Conductive ashes* | 6-10 | % |
| Polarization** | 99-99.8 | % |
| Moisture** | <0.3 | % |
| Ashes** | <0.25 | % |
| IMPURITIES: | | |
| Iron | 200 max | ppm |
| Silicon | 250 max | ppm |
| Nickel | traces | |
| Vanadium | 150 max | ppm |
| Calcium | 200 max | ppm |
| Sodium | 100 max | ppm |

*Basic composition of molasses
**Basic Composition of sugar
ppm = parts per million;
max = maximum;
Pol/Polarization = sucrose contents

According to the alternate embodiments, the typical composition of the petroleum coke to be used in the anode composition shows preferably the features given in Table V below, which can occur individually or simultaneously.

TABLE V

| | RANGE | UNIT |
|---|---|---|
| PARAMETER | | |
| Apparent density | 0.8-0.9 | g/cm³ |
| Real density | 1.9-2.1 | g/cm³ |
| Volatiles | 0.1-0.5 | % |
| Ashes | 0.1-0.6 | % |
| Moisture | 0-0.3 | % |
| IMPURITIES: | | |
| Iron | 400 max | ppm |
| Silicon | 300 max | ppm |
| Nickel | 300 max | ppm |
| Vanadium | 400 max | ppm |
| Sodium | 200 max | ppm |
| Calcium | 300 max | ppm |
| Sulfur | 3.0 max | % |

ppm = parts per million
max = maximum

The alternate embodiments of the invention will be described in relation to the same example given for the first embodiment of the invention, and in a similar way, such example shall not be considered as limiting the scope and conditions of the addition certificate in question.

Comparative tests were conducted in the laboratory by varying the conditions of the anode composition and the process for the manufacture thereof, to attain the best possible parameters, which could serve as a reference for the industrial process for the production of pre-baked anodes in the primary aluminum industry.

Thus, the experiments have been performed in bench scale equipment supplied by R.D.C., whereby 5 kg of paste were obtained in each test, which is equivalent to the production of 14 anodes of 340 g each.

The composition of the sugars used in the experiments is shown in table VI.

TABLE VI

| | BROWN | HARD | |
|---|---|---|---|
| PARAMETER | SUGAR | SUGAR | CRYSTAL SUGAR |
| Polarization (° S) | 83,3 | 63,2 | 99,8 |
| Conductive Ashes(%) | 2,16 | 1,31 | 0,04 |
| Calcium (ppm) | 1280 | 1400 | 100 |
| Sodium (ppm) | 100 | 300 | <0,01 |

The features of the process that showed the best results were:
Concentration of Brown Sugar, Hard Sugar or Crystal, = 16%-20%;
Mixing temperature of mixture = 135° C.-170° C.;
Baking temperature = 1100° C.

The anodes of the present improvement were also compared to conventional anodes that use electrolytic pitch as the binding agent.

The results are given below in Table VII.

TABLE VII

| | INVENTION | | | BROWN | | HARD | | CRYSTAL | | CONV. |
|---|---|---|---|---|---|---|---|---|---|---|
| | (MOLASSES) | | | SUGAR | | SUGAR | | SUGAR | | (pitch) |
| | 18% | 18% | 20% | 15% | 20% | 15% | 20% | 16% | 18% | 14.5% |
| PROPERTIES OF | ST = 4 | ST = 2 | ST = 20 | ST = 2 | ST = 20 | ST = 3 | ST = 3 | ST = 3 | ST = 3 | ST = 2 |
| THE ANODE | h | 0h | h | 0h | h | 0h | 0h | 0h | 0h | 0h |
| APARENT DENSITY | 1.583 | 1.607 | 1.610 | 1.584 | 1.522 | 1.591 | 1.582 | 1.627 | 1.630 | 1.577 |
| (GA); g/cm3 | | | | | | | | | | |
| APARENT DENSITY | 1.442 | 1.446 | 1.471 | 1.440 | 1.348 | 1.460 | 1.463 | 1.476 | 1.447 | 1.530 |
| (BA) g/cm3 | | | | | | | | | | |
| REAL DENSITY; | 2.093 | 2.089 | 2.090 | 2.089 | 2.092 | 2.091 | 2.093 | 2.085 | 2.079 | 2.125 |
| g/cm3 | | | | | | | | | | |
| CRUSHING | 318 | 224 | 209 | 235 | 205 | 181 | 201 | 260 | 209 | 263 |
| STRENGTH.: kgf/cm2 | | | | | | | | | | |
| ELECTRIC | 8583 | 8738 | 7541 | 7815 | 7819 | 10545 | 9640 | 8987 | 8181 | 7995 |
| RESISTIVITY.; | | | | | | | | | | |
| μOhm · cm | | | | | | | | | | |
| AIR PERMEABILITY; | 1.563 | 1.582 | 1.401 | 1.292 | 0.562 | 1.196 | 0.584 | 0.796 | 1.050 | 1.982 |
| nPm | | | | | | | | | | |
| THERMAL | 2.12 | 2.16 | 2.10 | 2.48 | 1.84 | 2.40 | 2.51 | 1.88 | 2.04 | 2.1 |
| CONDUCTIVITY, | | | | | | | | | | |
| w/m ° k. | | | | | | | | | | |
| AIR REACTIVITY | 55.7 | 69.5 | 68.9 | 66.0 | 64.9 | 64.4 | 73.6 | 60.1 | 61.6 | 71.6 |
| RESIDUE; % | | | | | | | | | | |
| CO2 REACTIVITY | 58.2 | 57.5 | 65.4 | 70.6 | 69.8 | 81.8 | 80.1 | 67.9 | 71.6 | 81.5 |
| RESIDUE, % | | | | | | | | | | |

ST = “soaking time” at baking temperature; in hours;
GA = green anode;
BA = baked anode.

ST=“soaking time” at baking temperature; in hours;

GA=green anode;

BA=baked anode.

According to the data above in table VII, it can be seen that the properties of laboratory scale anodes made according to the improvement are equivalent to conventional anodes containing pitch. However, improvements are necessary and after these all the public health and work environment problems previously described related to the use of pitch will be eliminated.

1. An anode or Söderberg paste to be used in the electrolytic cells for producing primary aluminum wherein mascavo sugar, crystal sugar, brown sugar, VHP sugar, refined sugar or hardened molasses are used as coalescing agents instead of the electrolytic pitch used in conventional processes of the production of anodes for the primary aluminum industry.

2. The anode or Söderberg paste according to claim 1, comprising the composition of approximately 50 to 70% by weight of petroleum coke, 15 to 30% by weight of anode butts, and 10 to 25% of mascavo sugar, crystal sugar, brown sugar, VHP sugar, refined sugar or hardened molasses.

3. The anode or Söderberg paste according to claim 1, comprising, additives based on lithium, fluorine, aluminum, alumina, boron, sulfur or the mixtures thereof.

4. The anode or Söderberg paste according to claim 2, comprising additives based on lithium, fluorine, aluminum, alumina, boron, sulfur or the mixtures thereof.

5. An anode or Söderberg paste wherein primary sugar honey (a whole syrup before the sugar is removed therefrom) is used for the same end, at the same proportion and with the same additives described for the mascavo sugar, crystal sugar, brown sugar, VHP sugar, refined sugar or hardened molasses in claim 3.

6. An anode or Söderberg paste to be used in the electrolytic cells for producing primary aluminum wherein crystal sugar, brown sugar, VHP sugar, refined sugar or hardened molasses are used as coalescing agents instead of the electrolytic pitch used in conventional processes of the production of anodes for the primary aluminum industry.

7. The anode or Söderberg paste according to claim 6, comprising the composition of approximately 50 to 70% by weight of petroleum coke, 15 to 30% by weight of anode butts, and 10 to 25% of crystal sugar, brown sugar, VHP sugar, refined sugar or hardened molasses.

8. The anode or Söderberg paste according to claim 6, comprising, additives based on lithium, fluorine, aluminum, alumina, boron, sulfur or the mixtures thereof.

9. The anode or Söderberg paste according to claim 7, comprising additives based on lithium, fluorine, aluminum, alumina, boron, sulfur or the mixtures thereof.

10. An anode or Söderberg paste wherein primary sugar honey (a whole syrup before the sugar is removed therefrom) is used for the same end and at the same proportion described for the mascavo sugar, crystal sugar, brown sugar, VHP sugar, refined sugar or hardened molasses in claim 2.

11. An anode to be used in the electrolytic production of primary aluminum wherein crystal sugar, brown sugar, VHP sugar, refined sugar, or hardened molasses are used as binding agents of the components thereof.

12. An anode according to claim 11 comprising, preferably, approximately 16% by weight of crystal sugar, brown sugar, VHP sugar, refined sugar or hardened molasses.

13. An anode according to claim 11 comprising additives based on lithium, fluorine, aluminum, alumina, boron, sulfur or the mixtures thereof.

14. An anode according to claim 13 wherein the additive content is approximately 0 to 10% by weight.

15. An anode according to claim 11 wherein the crystal sugar, brown sugar, VHP sugar, refined sugar or hardened molasses has at least one of the characteristics of a refractometric brix of about 75 to 83%, a Pol of about 37 to 63%, a purity of about 50 to 75%, reducing sugars of about 3 to 10%, and conductive ash of about 5 to 10%.

16. An anode according to claim 11 wherein the crystal sugar, brown sugar, VHP sugar, refined sugar, or hardened molasses shows a maximum content of impurities such as iron, silicon, nickel, vanadium, sodium, and calcium of about 250 ppm.

17. An anode according to claim 11 wherein the petroleum coke has at least one of the characteristics of an apparent density of about 0.8 to 0.9 g/cm³, a volatiles content of about 0.1 to 0.5%, an ashes content of about 0.1 to 0.6%, and a humidity content of about 0 to 0.3%.

18. An anode according to claim 11 wherein the petroleum coke shows a maximum content of impurities such as iron, silicon, nickel, vanadium, sodium, and calcium of about 400 ppm, and a sulfur content of about 3.0%.

19. A process for the manufacture of anode according to claim 11 which process comprises:
preparing a mixture containing petroleum coke, anode butts and crystal sugar, brown sugar, VHP sugar, refined sugar or hardened molasses;
crushing, sieving and classifying of the petroleum coke and anode butts;
heating of the classified fractions in a mixture with crystal sugar, brown sugar, VHP sugar, refined sugar or hardened molasses at a temperature ranging from 150° C. to 250° C.

20. A process for the manufacturing of anode according to claim 19 wherein the mixture heating temperature is about 190° C.

21. A process for the manufacturing of anode according to claim 19 wherein the product of said heated mixture is a slurry which may be directly used in electrolytic reduction vats or may be pressed or compacted or vibrocompacted in proper presses or compactors, with or without vacuum, in order to produce green anodes.

22. A process of the manufacturing of anode according to claim 21 wherein said green anodes are submitted to baking in special furnaces at temperature ranging from 800° C. to 1,300° C.

23. A process for the manufacturing of anode according to claim 21 wherein said green anodes are baked for a time ranging from 70 to 200 hours.

24. A process for the manufacturing of anode according to claim 21 wherein the baking temperature of the green anodes is about 1,100° C.
